(19) United States
(12) Patent Application Publication
(10) Pub. No.: US 2021/0036942 A1
(43) Pub. Date: Feb. 4, 2021

(54) SYSTEMS AND METHODS FOR IDENTIFYING PERSISTENTLY CONGESTED QUEUES

(71) Applicant: Dell Products, LP, Round Rock, TX (US)

(72) Inventors: Anoop Ghanwani, Roseville, CA (US); Bhargav Bhikkaji, San Jose, CA (US); Abhishek Mishra, San Jose, CA (US)

(73) Assignee: Dell Products, LP, Round Rock, TX (US)

(21) Appl. No.: 16/530,932

(22) Filed: Aug. 2, 2019

(51) Int. Cl. H04L 12/26; H04L 12/935

(52) U.S. Cl. CPC H04L 43/0882; H04L 43/16; H04L 49/3027

(57) ABSTRACT

A method of identifying persistently congested queues among a plurality of ports on a switch may include polling a queue length associated with each port; determining that a queue associated with a first port is persistently congested; and initiating and maintaining egress sFlow monitoring of the first port when the queue associated with a first port is persistently congested until the queue associated with the first port is no longer persistently congested.

### FIELD OF THE DISCLOSURE

The present disclosure generally relates to packet-switching networks. The present disclosure more specifically related to systems and methods of managing queues among a plurality of ports on a switch.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. In addition, the information handling systems may include a variety of hardware, firmware, and/or software components and may communicatively couple devices on a computer network by that receive, process, and forward data to a destination device.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram illustrating a switch according to an embodiment of the present disclosure;

FIG. 3 is a block diagram illustrating a switch according to an embodiment of the present disclosure;

FIG. 4 is a flow diagram illustrating a method of identifying persistently congested queues among a plurality of ports on a switch according to an embodiment of the present disclosure; and

FIG. 5 is a flow diagram illustrating a method of identifying persistently congested queues among a plurality of ports on a switch according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Embodiments of the present disclosure provide for initiating a packet monitoring process such as sFlow monitoring when a queue has been discovered to be persistently congested. The methods and systems may continually determine whether or not a queue is persistently congested by determining whether a latched queue length threshold in at least “x” of the last “m” polling intervals has been reached. A latched queue length may be used to report a maximum value of the queue length detected subsequent to a last reading of a queue length register. Once the queue length register is read, the queue length value is reset to the length to 0, the maximum queue length value is reported, and the queue length register monitors for another maximum queue length value until a next reading. Accordingly, a latched queue length threshold may be a maximum value of the queue length that exceeds a threshold value. Various other statistics may be used in determining whether any given queue is persistently congested such as link utilization data, packet loss at any given queue, instantaneous queue length data, and explicit congestion notification (ECN) statistics, among others. With this data, an sFlow monitoring process may continue until it is determined that the given queue is no longer persistently congested.

In an embodiment, an sFlow process may be implemented to monitor any given persistently congested queue. In addition to providing sFlow monitoring upon detection of a persistently congested queue, the systems and methods described herein may modify the sFlow monitoring process that looks to only the headers of the sampled packets in order to determine whether the sampled packets were destined for the persistently congested queue. In an embodiment, sFlow egress monitoring may be used at a port to avoid interference with a collector's activity, which typically depends on sFlow ingress monitoring at a port, should a network switch system be used in a monitor with collector capability instead or in addition to the present embodiments. Thus, the present systems and methods may reduce the cost on processing resources during operation. Still further, because the CPU and/or NPU may be used to complete the methods described herein, no additional hardware is used in order to supplement the resources already present on the switch. This reduces the operating costs of the network generally while still being provided data related to how the network and the switch in particular are operating. Thus, network congestion statistics may be made available to administrators of a network via implementation of the methods and systems using existing hardware as described herein without expensive collectors and off-switch analysis utilizing external hardware and on-switch processing.

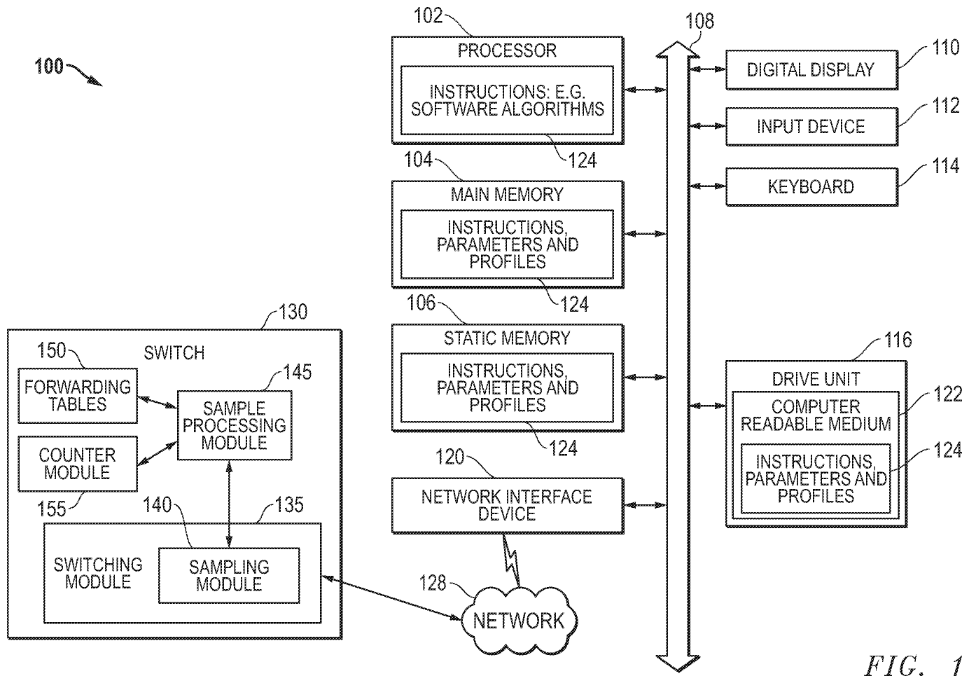

FIG. 1 illustrates an information handling system 100 similar to information handling systems according to several aspects of the present disclosure. In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 can be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP), a base station transceiver, a wireless telephone, a land-line telephone, a control system, a camera, a scanner, a facsimile machine, a printer, a pager, a personal trusted device, a web appliance, or any other suitable machine capable of executing a set of instructions (sequential or otherwise) that specify actions to be taken by that machine, and can vary in size, shape, performance, price, and functionality.

In a networked deployment, the information handling system 100 may operate in the capacity of a server or as a client computer in a server-client network environment, or as a peer computer system in a peer-to-peer (or distributed) network environment. In a particular embodiment, the information handling system 100 can be implemented using electronic devices that provide voice, video or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or multiple sets, of instructions to perform one or more computer functions.

The information handling system can include memory (volatile (e.g. random-access memory, etc.), nonvolatile (read-only memory, flash memory, etc.) or any combination thereof), one or more processing resources, such as a central processing unit (CPU), a graphics processing unit (GPU), hardware or software control logic, or any combination thereof. Additional components of the information handling system 100 can include one or more storage devices, one or more communications ports for communicating with external devices, as well as, various input and output (I/O) devices, such as a keyboard, a mouse, a video/graphic display, or any combination thereof. The information handling system 100 can also include one or more buses operable to transmit communications between the various hardware components. Portions of an information handling system 100 may themselves be considered information handling systems 100.

Information handling system 100 can include devices or modules that embody one or more of the devices or execute instructions for the one or more systems and modules described herein, and operates to perform one or more of the methods described herein. The information handling system 100 may execute code instructions 124 that may operate on servers or systems, remote data centers, or on-box in individual client information handling systems according to various embodiments herein for communication via one or more network switches and server systems. In other embodiments, the information handling system may operate as a switch 130 utilizing some or all components of the information handling system 100. In some embodiments, it is understood any or all portions of code instructions 124 may operate on a plurality of information handling systems 100.

The information handling system 100 may include a processor 102 such as a central processing unit (CPU), control logic or some combination of the same. Any of the processing resources may operate to execute code that is either firmware or software code. Moreover, the information handling system 100 can include memory such as main memory 104, static memory 106, and drive unit 116 (volatile (e.g. random-access memory, etc.), nonvolatile (read-only memory, flash memory, etc.) or any combination thereof). The information handling system 100 can also include one or more buses 108 operable to transmit communications between the various hardware components such as any combination of various input and output (I/O) devices.

The information handling system 100 may further include a video display 110. The video display 110 in an embodiment may function as a liquid crystal display (LCD), an organic light emitting diode (OLED), a flat panel display, a solid-state display, or a cathode ray tube (CRT). Additionally, the information handling system 100 may include an input device 112, such as a cursor control device (e.g., mouse, touchpad, or gesture or touch screen input, and a keyboard 114). The information handling system 100 can also include a disk drive unit 116.

The network interface device 120 shown as wireless adapter can provide connectivity to a network 128, e.g., a wide area network (WAN), a local area network (LAN), wireless local area network (WLAN), a wireless personal area network (WPAN), a wireless wide area network (WWAN), or other networks. Connectivity may be via a wired or a wireless connection via network interface device 120. The wireless adapter may operate in accordance with any wireless data communication standards. To communicate with a wireless local area network, standards including IEEE 802.11 WLAN standards, IEEE 802.15 WPAN standards, WWAN such as 3GPP or 3GPP2, or similar wireless standards may be used. In some aspects of the present disclosure, network interface device 120 may operate two or more wired or wireless links.

Utilization of radiofrequency communication bands according to several example embodiments of the present disclosure may include bands used with the WLAN standards and WWAN carriers, which may operate in both licensed and unlicensed spectrums. For example, both WLAN and WWAN may use the Unlicensed National Information Infrastructure (U-NII) band which typically operates in the ˜5 MHz frequency band such as 802.11 a/h/j/n/ac (e.g., center frequencies between 5.170-5.785 GHz). It is understood that any number of available channels may be available under the 5 GHz shared communication frequency band. WLAN, for example, may also operate at a 2.4 GHz band. WWAN may operate in a number of bands, some of which are proprietary but may include a wireless communication frequency band at approximately 2.5 GHz band for example. In additional examples, WWAN carrier licensed bands may operate at frequency bands of approximately 700 MHz, 800 MHz, 1900 MHz, or 1700/2100 MHz for example as well. Wireless adapter, as a network interface device 120 may connect to any combination of macro-cellular wireless connections including 2G, 2.5G, 3G, 4G, 5G or the like from one or more service providers.

In some embodiments, software, firmware, dedicated hardware implementations such as application specific integrated circuits, programmable logic arrays and other hardware devices can be constructed to implement one or more of some systems and methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a controller or a processor system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions, parameters, and profiles 124 or receives and executes instructions, parameters, and profiles 124 responsive to a propagated signal, so that a device connected to a network 128 can communicate voice, video or data over the network 128. Further, the instructions 124 may be transmitted or received over the network 128 via the network interface device 120 that is a wired or wireless adapter.

The information handling system 100 can include a set of instructions 124 that can be executed to cause the computer system to perform any one or more of the methods or computer-based functions disclosed herein. Various software modules comprising application instructions 124 may be coordinated by an operating system (OS), and/or via an application programming interface (API). An example operating system may include Windows®, Android®, and other OS types. Example APIs may include Win 32, Core Java API, or Android APIs.

The disk drive unit 116 may include a computer-readable medium 122 in which one or more sets of instructions 124 such as software can be embedded. Similarly, main memory 104 and static memory 106 may also contain a computer-readable medium for storage of one or more sets of instructions, parameters, or profiles 124 including an estimated training duration table. The disk drive unit 116 and static memory 106 may also contain space for data storage. Further, the instructions 124 may embody one or more of the methods or logic as described herein.

Main memory 104 may contain computer-readable medium (not shown), such as RAM in an example embodiment. An example of main memory 104 includes random access memory (RAM) such as static RAM (SRAM), dynamic RAM (DRAM), non-volatile RAM (NV-RAM), or the like, read only memory (ROM), another type of memory, or a combination thereof. Static memory 106 may contain computer-readable medium (not shown), such as NOR or NAND flash memory in some example embodiments. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In other embodiments, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

When referred to as a “system”, a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include software, including firmware embedded at a device, such as an Intel® Core class processor, ARM® brand processors, Qualcomm® Snapdragon processors, or other processors and chipsets, or other such device, or software capable of operating a relevant environment of the information handling system. The system, device, controller, or module can also include a combination of the foregoing examples of hardware or software. In an embodiment an information handling system 100 may include an integrated circuit or a board-level product having portions thereof that can also be any combination of hardware and software. Devices, modules, resources, controllers, or programs that are in communication with one another need not be in continuous communication with each other, unless expressly specified otherwise. In addition, devices, modules, resources, controllers, or programs that are in communication with one another can communicate directly or indirectly through one or more intermediaries.

The information handling system 100 may communicate with or may embody a switch 130. In some embodiments presented herein, the switch 130 may be coupled to a computing device that includes the processor 102, the main memory 104, the static memory 106, the video display 110, the input device 112, the keyboard 114, the drive unit 116, and the network interface device 120 enabling switched communication from information handling system 100 as described herein. The switch 130 may be any type of device that communicatively couples a plurality of network devices such as information handlings systems or other switches together by using packet switching to receive, process, and forward data from a sending device and to a destination device. In examples presented herein, the switch 130 may be coupled to an information handling system or a plurality of devices that each or together include the processor 102, the main memory 104, the static memory 106, the video display 110, the input device 112, the keyboard 114, the drive unit 116, and the network interface device 120 as described herein. As described further herein, switch 130 may be an information handling system including one or more processors 102, main memory 104, static memory 106 or other components as described herein.

In an embodiment, the switch 130 may include a switching module 135. The switching module 135 may be any device that receives packets from a network device and forwards those packets onto other network devices. In an embodiment, the switching module 135 may be any combination of hardware, computer-readable program code, or firmware that completes the tasks of the switching module 135 as described herein. In a specific embodiment, the switching module 135 may be an ASIC that completes the tasks of the switching module 135 as described herein. The process of forwarding the packets may include accessing header information associated with each packet and queuing each packet so that it may be forwarded onto the network device according to the information found in the header. In an embodiment, the switching module 135 may access a processor associated with the switch 130 so as to complete the process of reading headers and routing packets as described herein.

As mentioned, in some embodiments presented herein, the switching module 135 may queue the received packets for rerouting by the switch 130 to certain network devices via one or more buffer memory devices. The switch 130 may queue the packets by indicating a sequence as to which order any number of packets are sent out from the switch 130. In an example, the switch may include any number of ingress ports at which the switch 130 receives packets and a number of egress ports from which the switch 130 sends the packets out to other networked devices. The number of ingress and egress ports may vary from switch 130 to switch 130. However, in certain circumstances, the switching module 135 may direct a plurality of packets to be sent to a networked device communicatively coupled to the switch 130 via one or more specifically identified egress ports. Because these packets are to be routed to that networked device, each packet may be queued so that the packets may be sent to the networked device via that specifically identified egress port. When the packets received by the switch 130 and switching module 135 are to be sent out of this single egress port, the packets may be queued or lined-up for delivery in an order determined by the switching module 135. In an example, the order may vary depending on certain criteria associated with each packet, the time the packets were received by the switch 130, the ingress port of the packet, the QoS assigned to the packet, among other factors.

In an embodiment, the switching module 135 may include a sampling module 140. The sampling module 140 may be any combination of hardware, computer-readable program code, or firmware that completes the tasks of the sampling module 140 as described herein. In a specific embodiment, the sampling module 140 may be an ASIC that completes the tasks of the sampling module 140 as described herein. In an embodiment, the sampling module 140 may sample any number of packets received at the switch 130 and specifically the switching module 135. In an embodiment, on average (or alternatively exactly), a single packet out of “N” number of packets received by the switching module 135 are sampled. Packet sampling may be used as a method of monitoring network traffic from and to any number of networked devices. The purposes in monitoring network traffic (i.e., the number of packets sent and received) may include determining network packet transfer capabilities and current packet traffic, determining high traffic networked devices and/or applications running on those devices, updating software associated with networked devices, and updating any hardware associated with networked devices, among other purposes.

During operation, the switch 130 may implement a sample processing module 145 (for example, a module executing an sFlow process) to continuously monitor packet traffic at the switch 130 for episodes of time according to embodiments described herein. In some embodiments, the sample processing module may use sFlow. In other embodiments, the sample processing module may use other methods such as Packet Sampling (PSAMP) protocol and Internet Protocol Flow Information Export (IPFIX) protocol. The sample processing module 145 may be any combination of hardware, computer-readable program code, or firmware that completes the tasks of the sample processing module 145 as described herein. In a specific embodiment, the sample processing module 145 may be an ASIC that completes the tasks of the sample processing module 145 as described herein. The sample processing module 145 may execute an sFlow process when, in an embodiment, it has been determined that a queue length with any port is persistently congested. The sample processing module 145 may execute an sFlow process until any of the ports that are persistently congested are no longer persistently congested as described in detail herein.

As an example, the sFlow process that may be utilized with current information handling systems, unlike the presently described application of sFlow process herein, continuously samples packets passing through the switch 130. The sFlow process detects, diagnosis, and fixes certain issues associated with a network such as congestion associated with a number of queues within the switch 130. Application functionalities may be built on top of the code associated with the sFlow code to evaluate quality of service (QoS), move packet flows from port to port, detect security violations, and detect network outages or malfunctions, among other tasks. However, unlike other types of information handling systems that implement the sFlow process, the present system implements the sFlow process upon detection that any of the egress ports associated with the switch 130 are persistently congested as an on-switch process. Thus, in the embodiments presented herein, the method and systems prevent the sFlow process from initiating when no persistent congestion is detected at any given egress port. This allows the switch 130 to reserve a relatively more significant amount of processing resources by preventing the execution of the sFlow process at all times of operation of the switch 130. Still further, by limiting the execution of the sFlow process (or any other sampling processes) to those instances when a persistently congested queue is detected, data associated with the sFlow's sampling process is also significantly reduced saving storage space and bandwidth on the switch 130.

In an embodiment, the switch 130 may initiate a process of polling a queue length associated with each port. In a specific embodiment, the queue length may be polled using a latched queue length method. In this example, the sampling module 140 or a processor associated with the switch 130 may determine a current queue length associated with any given port and/or a maximum queue length associated with any given port. In this example, a buffer (i.e., any type of data storage device) may maintain packets that have been queued for delivery from the switch 130. This polling, due to the high frequency of packet transmission, may be completed at the switch hardware or using a gate array (i.e., a field-programmable gate array (FPGA)) on the switch 130. Despite whether hardware or computer-readable program code is used to poll the queue length associated with any port, this polling may be conducted every “n” seconds. In an example, the coefficient “n” may be defined in terms anywhere from sub-microseconds, or lower, to seconds. The latched queue length method described herein, therefore, may provide a maximum queue length reached at any port during the last “n” seconds. This latched queue length method may also provide a measure of the worst latency reported for any given queue where those queues are the sole queues presented at those specific ports.

By way of example only, a central processing unit (CPU) communicatively associated with the switch 130 may poll the queue length associated with any given port every 10 seconds. In continuation with the examples previously presented, a certain amount of history may be maintained. The number of polling data instances “m” may be maintained on a queue as the polling history associated with the switch 130 according to the latched queue length method described herein. If, in this example, “m” is 20, this may result in 200 seconds worth of information maintained by the switch 130 for each queue of each port. Although, specific examples are presented herein as to how often and how much polling data is maintained, the present specification contemplates that “n” and “m” may vary depending on any number of factors directed by any default settings inherent in the switch 130 and/or user created settings.

The CPU may then determine whether a queue associated with a first port is persistently congested. In the present description and in the appended claims the term “persistent congestion” may refer to any queue associated with any port that has a latched queue length that equals or exceeds a certain specified queue length threshold in at least “x” of the last “m” polling intervals. In an embodiment, the specified queue length threshold may be set to about 1.2 megabytes of queue length data maintained in the buffer. In other embodiments, the latched queue length threshold may be set to about 1.5 megabytes of queue length data maintained in the buffer for a given queue. In an embodiment, the specified queue length threshold may be set to any amount of queue length data maintained in the buffer by, for example, a network administrator. By way of example, if, in the last 200 seconds, a queue was reported as having a latched queue length of greater than 1 megabyte for 160 seconds, (i.e., 8 out of 10 polling intervals), the port associated with that queue may be determined to be persistently congested.

According to an embodiment, the queue may then be determined to not be persistently congested anymore when the CPU reports that the latched queue length is below the specified queue length threshold for, at least, “y” of the last “m” polling intervals. Again, by way of example only, if, in the last 200 seconds, any given queue is reported as having a latched queue length of less than 1 megabyte for 100 seconds (i.e., 5 out of the last 10 polling intervals), that port associated with that queue is deemed to no longer be persistently congested. In other embodiments, other methods to determine a persistently congested queue or determining that the queue is no longer persistently congested may be used such as those the rely on polling and queue lengths to be used. Additionally, other methods may be used such as link utilization and policers and the present disclosure contemplates these alternatives.

During operation, the latched queue length method described herein may report the maximum queue length during any given polling interval. This does not describe, however, a difference between two categories of queue congestion: 1) a queue whose queue length had “spiked” to a maximum level and then was emptied; and 2) a queue whose queue length has rendered the queue associated with a port occupied throughout an entirety of a polling interval. In order to alleviate this deficiency in data provided by the latched queue length method, link utilization data or additional metrics for determining persistent congestion may be captured by the CPU and used to differentiate between these two scenarios. Specifically, link utilization data may be data descriptive of the average number of bytes that cross a link in an interval t, which could be the same as or different from the polling interval, associated with any given port, polled by the CPU, divided by t times a native link speed associated with that port according to one embodiment. If this quotient is significantly less than 1, the CPU may then determine that the port is experiencing a queue length that is of the first type: a queue whose queue length had “spiked” to a maximum level and then was emptied. If this quotient is 1 or about 1, the CPU may then determine that the port is experiencing a queue length that is of the second type: a queue whose queue length has rendered the queue associated with a port occupied throughout an entirety of a polling interval.

Again, since the latched queue length method may not be capable of describing a difference between two categories of queue congestion: 1) a queue whose queue length had “spiked” to a maximum level and then was emptied; and 2) a queue whose queue length has rendered the queue associated with a port occupied throughout an entirety of a polling interval, link utilization may again be used in situations where multiple queues are sharing the same link or port in other embodiments. In this example, an estimate may be rendered, via execution of computer-readable program code by the CPU, as to the service rate (i.e., link utilization) of the multiples queues at the port. In an embodiment, a deficit weighted round-robin (DWRR) that is a scheduling method for the network scheduler that scans all non-empty queues in sequence such that when a non-empty queue is selected, its deficit counter is incremented (i.e., using the counter module 155) with the value of the deficit counter representing a maximal amount of bytes that can be sent at a time. In an embodiment, the counter 155 may extract statistics from the packet sampling describing the counts of the number of packets sampled over a given period of time among other statistical data. If the value present in the deficit counter is greater than the packet's size at the head of the queue, this packet can be sent and the value of the counter is decremented by the packet size.

As an additional consideration of determining persistent congestion in other embodiments, the latched queue length method described herein may account for packet loss. That is, at any given queue where packet loss has been detected, this would indicate congestion, for example an even greater congestion severity than either the two scenarios above: 1) a queue whose queue length had “spiked” to a maximum level and then was emptied; and 2) a queue whose queue length has rendered the queue associated with a port occupied throughout an entirety of a polling interval. In this example, an incremental counter value may be maintained at the counter module 155 that indicates the number of lost packets (i.e., discarded packets) at any given port. Lost packets may be a result of a maximum queue length being reached and, in an embodiment, these additional packets presented at the queue of any given port results in the discarding of those packets (and/or other packets maintained in the queue).

In an embodiment, an instantaneous queue length assessment may alternatively or additionally be used with the latched queue length method described herein to determine whether or not any given queue is persistently congested. In this example, the sampling module 140, under direction of the CPU, may determine the queue length at any given point in time and report that queue length to the CPU. Although this instantaneous queue length data is randomized and may not reflect an actual congestion situation at any given port, a high instantaneous queue length across polling intervals may indicate more severe congestion than a single instance of high instantaneous queue length recorded.

In an embodiment, explicit congestion notification (ECN) marking statistics may alternatively or additionally be used with the latched queue length method described herein. The ECN marking statistics may not always be displayed at the switch 130 or other end stations but may be enabled such that ECN-capable packets delivered from end-device to end-device via one or more network devices (for example, switches) indicate whether any queues are congested within any of these network devices (for example, switches) and/or end-devices.

In an embodiment, the policing processes may be used to measure congestion present at any queue. In this embodiment, an example policing process may include a virtual queue concept that identifies congestion even before a queue builds such as implementation of a high-bandwidth Ultra-Low Latency (HULL) architecture. The HULL architecture may implement phantom queues, data center transmission control protocol (DCTCP) congestion control, and packet pacing to accomplish this process. The implementation of phantom queues may be accomplished by attaching a policer to the switch and counting the number of packets and/or bytes that may contribute to a buildup of packets and/or bytes.

As described herein, once it has been determined that a queue associated with any of the ports is persistently congested, this may be designated as a queue of interest. Upon identification of any queue of interest, the methods and system described herein may initiate an egress sFlow monitoring process. This sFlow monitoring process may be initiated by the sample processing module 145 to report to, for example, an administrator those details of congestion experienced at any given switch 130 so as to provide network performance optimization and provisioning, accounting/billing for usage of the network, and defense against certain kinds of security threats to the network that may cause congestion.

In an embodiment, the sFlow monitoring process may monitor multiple queues on a single port within the switch 130. In the methods presented herein, the sFlow monitoring process may specifically be initiated at those ports that have queues which are determined to be persistently congested. This may allow for relatively higher sampling rates at those ports relative the sFlow monitoring process being initiated at every port of the switch 130. Additionally, the sampling rate may be set to the highest sampling rate sustainable at that port so as to receive the most data regarding the persistent congestion as possible. In an embodiment, the sampling rate may be set to a fixed value based on the transmission speed of that given port. In another embodiment, the sampling rate may be set at an initial value and increased or decreased based on a load at the CPU of the switch 130. In this latter embodiment, the sampling rate may be set higher when it is determined that there are fewer persistently congested queues discovered to be present at the switch 130. This may provide for on-switch congestion analysis with limited processing resources on-board with the network switch.

During operation, in an embodiment, the samples provided by the sFlow monitoring process may be truncated to the smallest size possible so as to decrease the sample size and, thereby, decrease the available data presented during the sFlow monitoring process. Further, this truncation process may limit overall data amounts to further limit on-switch congestion processing. In some embodiments, the samples may be truncated to 64 or 128 bytes. However, other truncation levels exist that take into consideration the type of encapsulation used in connection with the packets received by the switch 130 and/or the level of visibility desired and/or processing capabilities available on the switch 130. That is, the type of packets used as well as the desired degree of requested information from the CPU and/or an administrator of the network may be adjusted such that data that truncation levels from the sample data may be specified by the CPU/administrator in order to better determine how to process information from those queues within the switch 130 that are persistently congested.

According to the present specification, the sFlow monitoring process is applied to only egress flow of packets at the switch 130. Although ingress flow, egress flow, or both may have the sFlow monitoring process applied thereto, by executing an ingress sFlow monitoring, ingress sFlow monitoring will have to be enabled on all ports in the switch 130 resulting in a relatively large number of samples. Instead, ingress sFlow monitoring may be used in other beneficial methods apart from the methods described herein in order to, for example, support other types of collector-based sFlow monitoring processes if a network switch is to be used with a collector supported network. Instead, by using egress sFlow monitoring in the embodiments described herein, a collector is not needed and instead the silicon and executed computer readable program code present on the switch 130 itself may be used to report flow statistics and/or other information to a CPU and/or network administrator without using additional devices either within the switch 130 or communicatively coupled to the switch 130.

In embodiments presented herein, the sFlow monitoring process may begin with receiving a number of packet samples from the sampling module 140. These sample packets may be received by a CPU of the switch 130 which may review the headers of each packet. The review of the headers of the packets allows the CPU to determine which queue the sampled packet would have been added to during the transfer of the packet by the switch 130 to another switch or to an end device within the network such as a computing device. Examples of header data that may be used to determine the queue any sampled packet is to be sent to is an internal metadata header added by the switch to incoming packets and removed from packets as they egress the switch, IEEE 802.1p priority bits in the VLAN header, or a differentiated service code point (DSCP) field in the IP header. In the example where an internal metadata header is used, a precise identification of which queue the packet is to be sent to may be identified, in an example embodiment. In other cases, further knowledge may be used related to the mapping of respective field, e.g. IEEE 802.1p priority bits in the VLAN header or DSCP in the IP header, to queue.

After determining which queue the sampled packets were to be sent to, the CPU of the switch 130 may disregard any samples whose identified recipient queue (per the header data as described herein) is not a queue of interest. In the present specification and in the appended claims, the term “queue of interest” is meant to be understood as the queue that the CPU of the switch 130 has identified as being persistently congested as described herein. In this case, where the header data of any sampled packet indicates that the destination queue is not a queue of interest, the sample may be discarded without further processing form the CPU thereby saving processing resources at the switch 130 for those packets whose headers do indicate that the corresponding packet was destined to a queue of interest.

Continuing with the operation of the switch 130, after finding a sample packet whose header indicates that the packet was sent to a queue of interest, the CPU may extract the n-tuple data (e.g. IP destination address (DA), IP source address (SA), IP protocol, and if the IP protocol is one that uses port numbers, e.g. TCP, UDP, SCTP, etc. then the source port number and destination port number) that is used to identify the flow that the packet was a part of found within the header of each packet of interest along with the packet length. In the case where the network virtualization overlays (NVOs) are used, additional fields may be used for flow identification such as the internet protocol (IP) destination address (DA) and source address (SA) and the transmission control protocol (TCP)/user datagram protocol (UDP) source and destination ports of the inner header can be identified by the CPU, in addition to other fields in the virtual extensible local area network (VXLAN) header such as the VXLAN network identifier (VNI) that can be used to identify the tenant of that flow. In an embodiment, the n-tuple found within the headers of each packet of interest and packet length data may be inserted or updated in a flow database. By looking at the n-tuple from the headers and packet length, the processing resources of the switch 130 may further reduce the data storage and processing power of the CPU while still identifying to the CPU the flow of packets at the persistently congested queues.

With the knowledge of the sampling rates presented by the sampling module 140, the CPU may estimate the rates of all flows of packets within the switch 130. This allows the sample processing module 145 to report the top flows of packets within the switch 130, the top tenants in a multitenant network that is using the persistently congested queue, all elephant flows using a disproportionate share of total bandwidth over a period of time in the switch 130 (i.e., present in the persistently congested queue), as well as any peak latencies observed within the queue based on the latched queue length value. Alternatively, instead of using the sampling rate to estimate the rates of all flows, the CPU may identify, using the sample processing module 145 in real-time, any elephant flows within the persistently congested queues. In general, a variety of flow information can be extracted to provide visibility about the activity of various flows, applications, and tenants using a congested queue.

By operation of the switch 130 as described herein, the identification and monitoring of persistently congested queues may be completed. As described herein, the switch 130 may not need any hardware or software changes. The CPU of the switch 130 may execute the computer-readable program code as described herein without relying on external hardware or software (i.e., a collector) to allow the switch 130 to provide data related to persistently congested queues. Thus, unlike other switch devices available, the methods described herein may be implemented entirely on the switch 130 using capabilities already available in existing switches. The methods may be implemented within a single switch so as to detect and classify persistent congestion allowing a report of those end devices, flows, tenants, applications, etc. that disproportionately use a relatively higher amount of bandwidth at the switch 130. Unlike other methods or systems, the present switch 130 may use the identification of a persistently congested queue as a trigger to initiate flow monitoring such as the sFlow monitoring process described herein. Additionally, unlike other types of switches, the flow monitoring process conducted by the switch 130 described herein may stop once it has been determined that any given queue associated with any port is no longer persistently congested. This reduces the use of processing resources available at the switch 130 while still providing customizable data related to the persistently congested queues. Still further, unlike other switch devices available, the present switch 130 implements a relatively more lightweight processing of sFlow samples by reviewing truncated header information of the sampled packets so as to provide packet and byte counts for any given flow and estimates of a flow rate at the persistently congested queue.

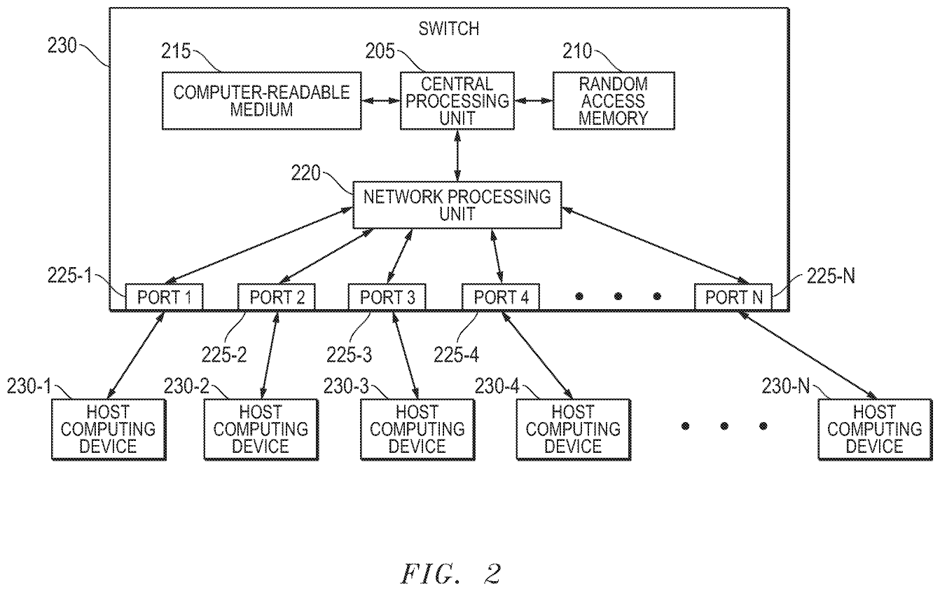

FIG. 2 is a block diagram illustrating a switch 230 according to an embodiment of the present disclosure. As described herein, the switch 230 may include a number of ports 225-1, 225-2, 225-3, 225-4, 225-N. Although FIG. 2 shows the switch 230 with a certain number of ports 225-1, 225-2,225-3, 225-4, 225-N, the present specification contemplates that the switch 230 may include any number of ports 225-1, 225-2, 225-3, 225-4, 225-N without restriction. These ports 225-1, 225-2, 225-3, 225-4, 225-N may be dedicated to ingress and egress communication through the switch and to packets destined to the switch itself 230.

The packets received by the switch 230 may be routed, via the switch 230, to any number of networked devices including other switches, routing devices, servers, as well as the host computing devices 230-1, 230-2, 230-3, 230-4, 230-N. The host computing devices 230-1, 230-2, 230-3, 230-4, 230-N may be any computing device that can be communicatively coupled to the switch 230 using any type of communication connection. In an example, the host computing devices 230-1, 230-2, 230-3, 230-4, 230-N may be communicatively coupled to the switch 230 using a wired or wireless connection. These wired or wireless connections may include an Ethernet connection, a Bluetooth ® connection, a near-field communication (NFC) connection, and a radio frequency connection, among others. In an embodiment, the host computing devices 230-1, 230-2, 230-3, 230-4, 230-N may implement a combination of a wired and wireless connections.

During operation of the switch 130, the switch 130 may receive packets from any of the host computing devices 230-1, 230-2, 230-3, 230-4, 230-N that each include a header that provides data related to the sending host computing device 230-1, 230-2, 230-3, 230-4, 230-N and a recipient networked device 230-1, 230-2, 230-3, 230-4, 230-N. Each packet is received at a port 225-1, 225-2, 225-3, 225-4, 225-N and processed by the network processing unit (NPU) 220. The NPU 220 may be any integrated circuit within the switch 230 that processes network packets as they are received by the switch 130. The NPU 220 may specifically identify specific patterns of bits or bytes within the packets in a stream of packets received by the switch 130. The NPU 220 may further be configured to manage any number of queues by receiving, processing, and scheduling the packets to be stored in buffer memory and organized into queues for eventual delivery. In this capacity, the NPU 220 may assist in identifying any persistently congested queues as described herein by providing processing resources that identify the n-tuple and provided in the headers of the packets and packet length data. Additionally, the NPU 220 may provide the processing resources used to determine which of the packets are to be queued at a persistently congested queue according to the methods described herein.

The processing resources of the NPU 220 may be augmented by the processing resources of a central processing unit (CPU) 205. In any example presented herein, the processing of any type of any packet or data associated with those packets may be completed by the CPU 205, the NPU 220, or a combined processing power of the NPU 220 and CPU 205. In a specific example, the CPU 205 may execute computer-readable program code maintained on a computer-readable medium 215. The computer-readable program code may include instructions that, when executed by the CPU 205 and/or NPU 220, performs the processes and methods described herein, namely: poll a queue length associated with each port, determine that a queue associated with a first port is persistently congested according to a congestion assessment criteria of latched queue length data, and initiate and maintain egress sFlow monitoring of the first port when the queue associated with a first port is persistently congested until the queue associated with the first port is no longer persistently congested. Additional processes may be executed by either or both of the NPU 220 and CPU 205 and the present description contemplates such use of the NPU 220 and CPU 205.

The switch 230 may also include one or more random access memory (RAM) 210. In an example, the RAM 210 may be any type of memory that stores any instructions or information used by the CPU 205 and/or NPU 220 during execution of the computer-readable program code described herein. In a specific embodiment where the RAM 210 is communicatively coupled to the NPU 220, the RAM 210 may serve as a buffer location to store the packets in a queue for eventual delivery by the switch 230 to a networked device such as the host computing devices 230-1, 230-2, 230-3, 230-4, 230-N. In another embodiment, a dedicated static random-access memory (SRAM) device is coupled to the NPU 220, the SRAM may be used as the buffer location as described.

In an embodiment described herein, the NPU 220 and/or CPU 205 may execute computer-readable program code that initiates packet monitoring at any discovered persistently congested port. As described herein, this packet monitoring may be sFlow monitoring. During execution of the sFlow monitoring process, the NPU 220 and/or CPU 205 may sample any number of packets received at the switch 230 and destined for the persistently congested queue as described herein. In an embodiment, on average, a single packet out of “N” number of packets received by the switch 230 is sampled and it may be determined whether the packet is destined for the persistently congested queue or not. Packet sampling may be used as a method of monitoring network traffic from and to any number of networked devices. The purposes in monitoring network traffic (i.e., the number of packets sent and received) may include determining network packet transfer capabilities and current packet traffic, determining high traffic networked devices, updating software associated with networked devices, and updating any hardware or provisioning associated with networked devices, among other purposes. In some embodiments presented herein, the sFlow monitoring process may specifically be used to determine which networked device, out of the networked devices communicatively coupled to the switch 230, any given monitored packet associated with the persistently congested queue is to be sent to.

In order to decrease the processing and data storage resources used in sampling the number of packets, the sFlow monitoring process may limit a review of the sampled packets to the headers and, in some embodiments to specific data within the header. This information specifically allows the NPU 220 and/or CPU 205 to identify whether the sampled packet is to be queued at the persistently congested queue. If not, the sampled packet is discarded at least as a sample and no longer processed during the sFlow monitoring process. Where the header has indicated that the destination is at an egress port associated with the persistently congested queue, the execution of the sFlow process may proceed with reporting latency within the switch 230, packet flow within the switch 230, top tenants within the multitenant network, whether any elephant flows exist in the persistently congested queue, and a peak latency of the persistently congested queue, among other data. This information may be received by a network administrator that can adjust the number of packets sampled at any given time as well as the details requested in the reported data by the NPU 220 and/or CPU 205.

Although the present description shows a single switch 230 being described, the present specification contemplates the use of multiple switches 230. In any example, multiple switches 230 may each monitor for persistently congested queues therein and initiate the sFlow monitoring process or any other packet monitoring process when those persistently congested queues are discovered. In the example where multiple switches 230 are used, each switch 230 may report their individual data regarding the persistently congested queues and sampled packets to the network administrator. This may allow a network administrator to specifically address each individual switch 230 within a network when congestion is discovered. Hardware and/or software adjustments may be made by the network administrator based on the data received by the switches 230 so as to optimize performance within the network and specifically packet delivery from one host computing devices 230-1, 230-2, 230-3, 230-4, 230-N to another 230-1, 230-2, 230-3, 230-4, 230-N.

Again, the switch 230 described in FIG. 2 does not implement any additional hardware internal or external to the switch 230 other than what had been originally provided at the switch 230. The processing power and existing silicon present on the switch 230 may be use to report the occurrence of persistently congested queues and report details on packets sampled and associated with that persistently congested queue. This may reduce the costs associated with the network generally while increasing the performance of the network and switches 230. The NPU 220 and/or CPU 205 may also be configured to allow a network administrator to specifically increase the number of packets sampled in order to increase the visibility of the data received. Still further, the NPU 220 and CPU 205 may receive instructions as to what data to report thereby allowing a network administrator to tune the switch 230 so as to receive the best data from the switch 230.

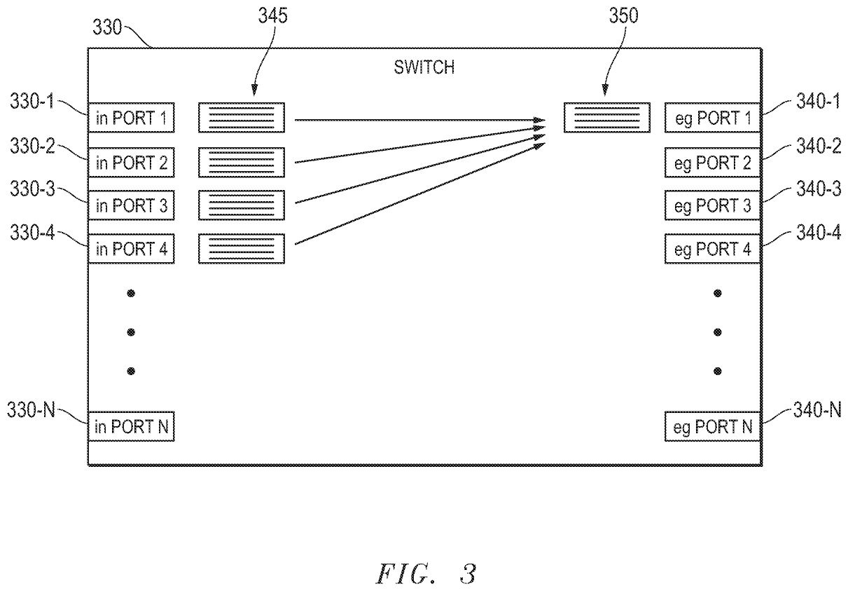

FIG. 3 is a block diagram illustrating a switch 330 according to an embodiment of the present disclosure. Similar to other embodiments presented herein, the switch 330 may include a number of ports: a plurality of ingress ports (in port) 330-1, 330-2, 330-3, 330-4, 330-N and a plurality of egress ports (eg port) 340-1, 340-2, 340-3, 340-4, 340-N. FIG. 3 schematically depicts the in ports 330-1, 330-2, 330-3, 330-4, 330-N and eg ports 340-1, 340-2, 340-3, 340-4, 340-N as separate ports, however, physically the in ports 330-1, 330-2, 330-3, 330-4, 330-N and eg ports 340-1, 340-2, 340-3, 340-4, 340-N may be the same port but function as a port that both receives (in port function) and outputs packets (eg port function) to any number of networked devices.

FIG. 3 also shows, schematically, a number of queues presented that may include ingress queues 345 and egress queues 350. In the examples presented in FIG. 3, the in ports 330-1, 330-2, 330-3, 330-4, 330-N may each have an ingress queue 345 associated with it and the eg ports 340-1, 340-2, 340-3, 340-4, 340-N may also have an egress queue 350 associated with it. In some embodiments, there may be more than one queue at an egress port and the order of service is determined by a scheduler. In some embodiments, the ingress queues may be part of a virtual output queueing implementation where there is a queue per egress queue at each ingress port or group of ingress ports. In some embodiments, ingress queues may not be present at all. For illustration, only egress queues are considered but the methods discussed can be applied at ingress queues. FIG. 3 specifically shows that a number of packets may be queued at an eg port 340-1, 340-2, 340-3, 340-4, 340-N, however, the present specification contemplates that any packets received at any in ports 330-1, 330-2, 330-3, 330-4, 330-N may be queued at any of the egress queues 350. Specifically, due to the operation of the latched queue length methods described herein, the queue at eg PORT 1 340-1 is meant to be identified as a queue of interest because it is persistently congested. Thus, according to certain embodiments presented herein, an NPU and/or CPU may determine whether any given queue is a persistently congested queue. As described herein, a persistently congested queue is any queue associated with any eg port 340-1, 340-2, 340-3, 340-4, 340-N that has a latched queue length threshold in at least “x” of the last “m” polling intervals. As described herein, additional factors may be considered in determining whether the queue is persistently congested or not. These additional factors include, but is not limited to, utilization, packet loss within a queue, or instantaneous queue length data, among other factors. In any embodiment described herein, the individual ingress queues 345 and egress queues 350 may be a list of packets received at and to be sent by, respectively, the switch 330. Network traffic, therefore, dictates whether any of the egress queues 350 are deemed to be persistently congested and the switch 330 implements the latched queue length methods described herein to monitor for such a persistent congestion at any of the eg ports 340-1, 340-2, 340-3, 340-4, 340-N.

Again, when the queue associated with an eg port 340-1 is determined to be persistently congested, this may initiate the packet monitoring processes described herein. Again, an example packet monitoring process may include sFlow process that may be modified or customized by a network administrator to increase the number of sample packets taken over a given period of time as well as customize the amount of processing resources used in identifying whether the packets are to be associated with the persistently congested queue or not and whether further details should be discovered related to those packets destined for the persistently congested queue. These details may be reported by the NPU and/or CPU of the switch 330 and may include reports regarding top flows using the persistently congested queue, the top tenants in a multitenant network using the persistently congested queue, whether any elephant flows are using the persistently congested queue, and a peak latency of the queue, top applications using the persistently congested queue, among other data.

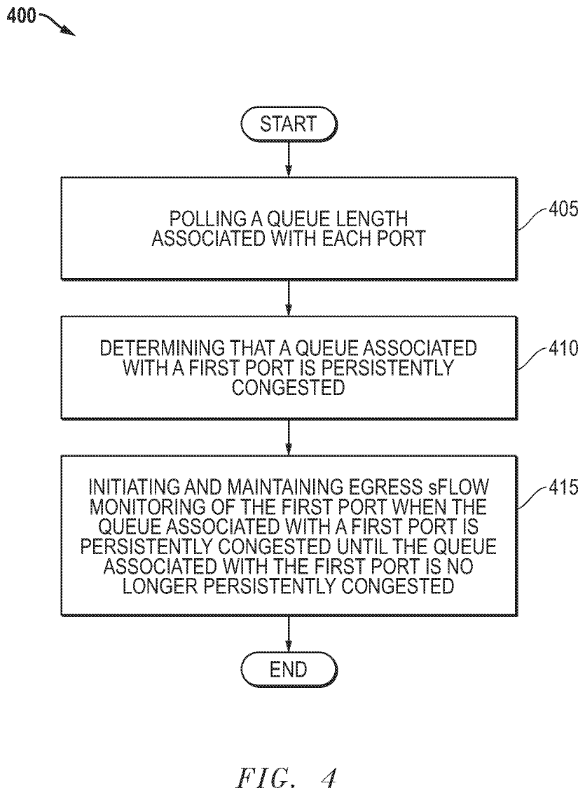

FIG. 4 is a flow diagram illustrating a method 400 of identifying persistently congested queues among a plurality of ports on a switch according to an embodiment of the present disclosure. The method 400 may begin with polling 405 a queue length associated with each port. Again, the polling 405 may be completed on a periodic basis to create a history of polled queue lengths with the history any polled queue lengths being maintained on, for example, a memory device associated with the switch. During operation of the switch, a CPU and/or NPU may execute code instructions to conduct the polling 405 of the queue lengths. As mentioned herein, the silicon present on the switch may conduct all process and methods described herein without implementing any physical changes to the hardware of the switch. This allows congestion monitoring for current switches such as the S5000 network switch, the S6100 network switch, and the Z9100 network switch produced and sold by Dell® Technologies. Thus, although other devices internal and external to the switch may complete the same congestion analysis different from the processes described herein, these devices are not used thereby reducing the costs associated with operating the network.

This polled queue length data at 405 may be used to the determine at 410 that a queue associated with a first port is persistently congested. Again, determining at 410 that a queue associated with a first port is persistently congested comprises determining whether any given latched queue length is greater than a threshold value for a number of intervals of polling the queue length. The latched queue length values may be monitored over several polling intervals. A persistent congestion criteria may involve a threshold number of queue lengths per polling episodes. This threshold value may be set by the switch or may be set by a network administrator for determination if queues of interest are potentially experiencing persistent congestion.

According to certain embodiments presented herein, implementing the latched queue length to poll the queue lengths is done every n seconds, where n is a predetermined number where, for historical reference by a CPU, the switch maintains a certain number of polled queue lengths. Additionally, the other assessment data may be used to differentiate between a temporary sharp increase in the queue length and a persistently congested queue length associated with the queue of interest at a first port. This differentiation may include determining a link utilization associated with any port during an interval so as to determine the average number of bytes that cross a link in an interval t, which could be the same as or different from the polling interval, associated with any given port, polled by the CPU, divided by t times a native link speed associated with that port according to one embodiment. Still further, the process described herein may take into consideration any data lost within a queue (i.e., dropped packets) in order to determine if the queue is persistently congested. These aspects may be used for confirmation that a queue of interest is persistently congested. Other metrics may also be used as with other embodiments described herein.

The method 400 may then continue with initiating and maintaining at 415 egress sFlow monitoring of the first port when the queue of interest associated with a first port is persistently congested until the queue of interest associated with the first port is no longer persistently congested. The present description therefore provides for a method 400 that initiates a packet monitoring process such as the sFlow monitoring only when it has been determined that any given queue of interest is a persistently congested queue. This specifically allows for the processing resources associated with the NPU and/or CPU of the switch to be conserved specifically for reporting on only the persistently congested queues of interest instead of all queues. Again, this reduces the use of other devices apart from the switch as well as reduces the costs associated with running the devices on the network while providing for network optimization assessment.

Additionally, the method 400 may initiate and maintain at 415 egress sFlow monitoring until the persistent congestion is no longer detected at that first port. As such, the sFlow process may indicate to a CPU and/or NPU that the sFlow monitoring may cease when the reported data indicates that the persistent congestion has subsided at that first port. Again, as described herein, a queue of interest is no longer persistently congested when it is determined that a latched queue length was below a certain threshold in at least “x” of the last “m” polling intervals. This calculation may, therefore, be conducted by the CPU and/or NPU continuously during the egress sFlow monitoring.

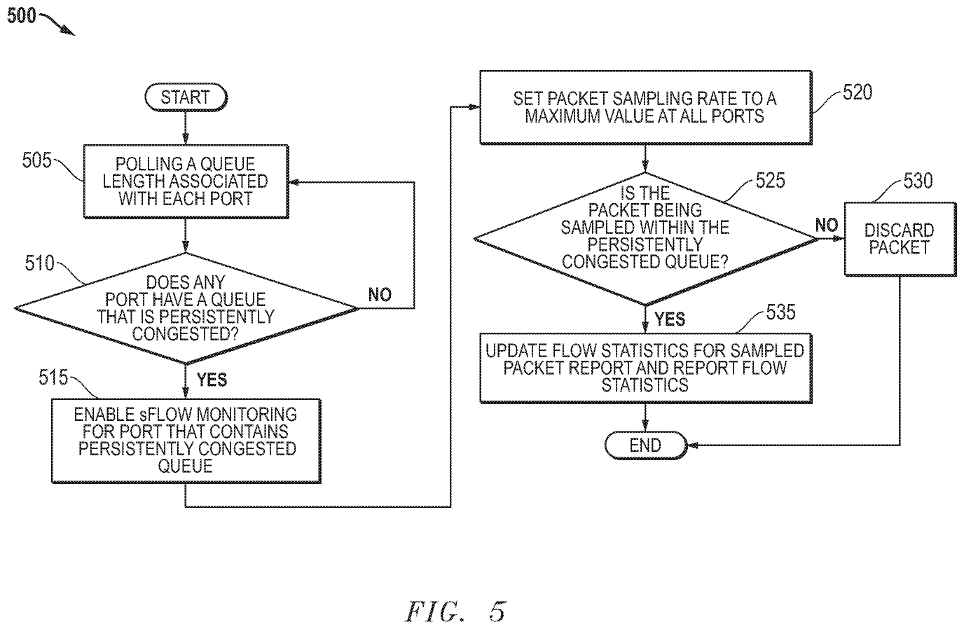

FIG. 5 is a flow diagram illustrating a method 500 of identifying persistently congested queues among a plurality of ports on a switch according to an embodiment of the present disclosure. The method 500 may start with polling, at 505, a queue length associated with each port. Again, the process of polling at 505 the queue length may include determining whether any given latched queue length value is greater than a threshold value for a number of periods of polling the queue length. The method 500, therefore, determines at 510 whether, based on the latched queue length value exceeding the threshold “x” of “m” polling intervals being met during example polling intervals, any port has a queue that is persistently congested. The process of determining at 510 whether any port has a queue that is persistently congested may be iterative. That is, the systems and methods may continually be searching for persistently congested queue. Where a persistently congested queue is not found (determination NO at 510), the process may return with polling 505 the queue lengths associated with each port.

Where a persistently congested queue is found to be associated with any of the ports (determination YES at 510) the method 500 may continue with enabling at 515 sFlow monitoring for ports that contain persistently congested queue. As part of the enabling sFlow monitoring for the discovered persistently congested queue or queue of interest the CPU and/or NPU may receive instructions to set, at 520, a packet sampling rate to a maximum value at all of the persistently congested ports. In an embodiment, the maximum value may be a value at which the system can adequately process the data which value may be determined by the number of ports having persistently congested queues as well as those ports' link speeds. In an embodiment, this maximum sampling rate may be dependent on a number of factors including, but not limited to, a user-input value, the capabilities of the NPU and/or CPU of the switch, and the amount and flow of packet traffic through the switch, among other factors.

The method 500 may also include a process of determining at 525 whether any given sampled packet is within the persistently congested queue of interest. That is, according to the sFlow process, the CPU and/or NPU may read the header of each sampled packet and determine at 525 whether the sampled packet is to be included in the persistently congested queue. Where any packet is determined not to be included within the persistently congested queue (determination NO at 525) the packet may be discarded at 530. Once the packet is discarded, the method as related to that packet may end.

However, when it is determined that the packet is to be included within the persistently congested queue of interest (determination YES at 525), may proceed at 535 with updating flow statistics for a sampled packet and reporting queue flow statistics associated with that packet among all other packets that have been determined (determination YES at 525) to be included within the persistently congested queue of interest. This may further include identifying the persistently congested queue of interest.

In an example, the method may conclude with stopping the sFlow monitoring process described herein when it is discovered that the queue of interest is no longer persistently congested. Again, as described herein, a queue is no longer persistently congested when it is determined that a latched queue length is below a threshold in at least “y” of the last “m” polling intervals has no longer been reached. The threshold “y” of “m” polling intervals for assessing no longer persistently congested queues may be same as the threshold “x” for persistent congestion above in some embodiments or it may be a different threshold value in other embodiments within the system. For example, the no longer persistently congested threshold “y” may be greater than “x” in some embodiments. This calculation may, therefore, be conducted by the CPU and/or NPU continuously during the egress sFlow monitoring, at 535.

The blocks of the flow diagrams of FIGS. 4 through 5 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A method of identifying persistently congested queues among a plurality of ports on a switch, comprising:
polling a queue length associated with each port;
determining that a queue associated with a first port is persistently congested; and
initiating and maintaining egress sFlow monitoring of the first port when the queue associated with a first port is persistently congested until the queue associated with the first port is no longer persistently congested.

2. The method of claim 1, wherein polling the queue length comprises:
polling the queue length on a periodic basis to create a history of polled queue lengths; and
maintaining the history of polled queue lengths defining a plurality of polling instances.

3. The method of claim 1, wherein determining that a queue associated with a first port is persistently congested comprises determining whether any given latched queue length is greater than a threshold value for a number of periods of polling the queue length.

4. The method of claim 1, wherein polling the queue length comprises:
implementing latched queue length to poll the queue lengths every n seconds, where n is an predetermined real number; and
maintaining a certain number of polled queue lengths for historical reference by a central processing unit.

5. The method of claim 1, wherein polling the queue length comprises:
implementing latched queue length to poll the queue lengths every n seconds where n is an predetermined real number; and
differentiating between a temporary sharp increase in the queue length and a persistently congested queue length associated with the first port, comprising:
determining a link utilization associated with any port during an interval so as to determine a link utilization ratio by dividing the average speed of packet delivery across the link by an interval times a native link speed.

6. The method of claim 1, wherein polling the queue length comprises:
implementing latched queue length to poll the queue lengths every n seconds where n is an predetermined real number; and
determining a severity of congestion based on whether data is lost at any given queue to indicate maximum queue length is insufficient.

7. The method of claim 1, wherein instantaneous queue length data across several polling intervals is used to determine that a queue associated with a first port is persistently congested.

8. The method of claim 1, wherein an explicit congestion notification marking statistic is used to determine that a queue associated with a first port is persistently congested.

9. A switch within a network, comprising:
a central processing unit (CPU);
a network processing unit (NPU) communicatively coupled to the CPU;
a plurality of ports to receive and transmit data; and
a sampling module to:
poll a queue length associated with each port;
determine that a queue associated with a first port among the plurality of ports is persistently congested;
initiating and maintaining egress packet sampling of the first port when the queue associated with a first port is persistently congested.

10. The switch of claim 9, wherein the sampling module polls the queue length on a periodic basis to create a history of polled queue lengths and maintains the history of polled queue lengths defining a plurality of polling instances.

11. The switch of claim 9, wherein the sampling module is communicatively coupled to a gate array, the gate array polls the queue length associated with each port.

12. The switch of claim 9, determining that a queue associated with a first port is persistently congested comprises, with the sampling module, determining whether any given latched queue length is greater than a threshold value for a number of periods of polling the queue length.

13. The switch of claim 9, comprising an sFlow module to initiate and maintain the packet sampling of the first port when the queue associated with a first port is persistently congested by setting a packet sampling rate to a maximum at all ports of the switch and report queue flow statistics related to those packets associated with the persistently congested queue.

14. The switch of claim 9, wherein the sampling module polls the queue length associated with each port by:
implementing latched queue length to poll the queue lengths every n seconds where n is an predetermined real number; and
differentiating between a temporary sharp increase in the queue length and a persistently congested queue length associated with the first port, comprising:
determining a link utilization associated with any port during an interval so as to determine the number of bytes that cross that link by dividing the average speed of packet delivery across the link by an interval times a native link speed.

15. The switch of claim 9, wherein the sampling module polls the queue length associated with each port by:
implementing latched queue length to poll the queue lengths every n seconds where n is an predetermined real number; and
determining a severity of congestion based on whether data is lost at any given port to indicate maximum queue length is insufficient.

16. A method of identifying persistently congested queues among a plurality of ports on a switch, comprising:
polling a queue length associated with each port;
determining that a queue associated with a first port is persistently congested;
initiating and maintaining egress sFlow monitoring of all ports when the queue associated with a first port is persistently congested;
set packet sampling rate to a maximum value at all ports to determine which packets among the sampled packets are associated with the persistently congested queue.

17. The method of claim 16, comprising reporting queue flow statistics to a computing device descriptive of the sampled packets associated with the persistently congested queue.

18. The method of claim 16, wherein determining which packets among the sampled packets are associated with the persistently congested queue comprises reviewing data associated with a header of each packet and discarding samples not destined for any persistently congested queue.

19. The method of claim 16, wherein polling the queue length comprises:
polling the queue length on a periodic basis to create a history of polled queue lengths; and
maintaining the history of polled queue lengths defining a plurality of polling instances.

20. The method of claim 16, wherein determining that a queue associated with a first port is persistently congested comprises determining whether any given latched queue length is greater than a threshold value for a number of periods of polling the queue length.
